(19) United States
(12) Patent Application Publication
(10) Pub. No.: US 2019/0232771 A1
(43) Pub. Date: Aug. 1, 2019

(54) DOOR ASSEMBLIES INCLUDING A GARNISH AND VEHICLES INCORPORATING THE SAME

(71) Applicant: Toyota Motor Engineering & Manufacturing North America, Inc., Erlanger, KY (US)

(72) Inventors: Scott P. Robison, Dexter, MI (US); Jonathan E. Huston, Portland, OR (US)

(21) Appl. No.: 15/884,647

(22) Filed: Jan. 31, 2018

(51) Int. Cl. B60J 10/76; B60J 10/79; B60R 13/00; B60J 10/27; B60J 10/30; B60J 5/04

(52) U.S. Cl. CPC B60J 10/76; B60J 10/79; B60R 13/00; B60J 5/04; B60J 10/30; B60J 5/0402; B60J 10/27

(57) ABSTRACT

A door assembly including a door frame, a frame member, and a garnish coupled to the frame member. The door frame at least partially defining a window opening. The door frame includes an outer door panel and an inner door panel. The outer door panel includes a window edge adjacent the window opening, a trailing edge, and an exterior surface extending between the window edge and the trailing edge. The inner door panel is coupled to and positioned inboard of the outer door panel in a vehicle lateral direction. The frame member is coupled to and positioned between the outer door panel and the inner door panel. The garnish covers a portion of the exterior surface of the outer door panel adjacent the window edge while permitting a vehicle body color of the exterior surface of the door outer panel between the garnish and the trailing edge to be exposed.

### TECHNICAL FIELD

The present specification generally relates to door assemblies for a vehicle, and more particularly, door assemblies including a garnish.

### BACKGROUND

It has been known to provide vehicles with press type door frames which provide for inner door frames and outer door frames to extend continuously around a window opening. As the inner door frames and outer door frames continuously around a window opening, press type door frames enable a vehicle body color to be exposed at a portion of the door frame between the window opening and a rear trailing edge of the door frame. The press type door frames also enable variable door frame dimensions as the portion of the door frame between the window opening and the rear trailing edge is able to be increased or decreased. However, the previously known press type door frames are unable to support an accent garnish between the window opening, specifically the movable glass window within the window opening and the rear trailing edge.

It has also been known to provide vehicles with hidden frame type doors that include an accent garnish. However, accent garnishes on hidden door frames form a portion of the rear trailing edge of the door frame. As such, the vehicle body color of the hidden frame type door frames is unable to be exposed at the portion of the door frame between the window opening and the rear trailing edge of the door frame, and the dimension of the hidden type door frame is fixed thereby preventing variable door frame dimensions.

Accordingly, there is a need for a door frame, for use in a vehicle, that accommodates the attachment of an accent garnish while allowing a vehicle body color to be exposed between the window opening and a rear trailing edge of the door frame and variable door frame dimensions as the portion of the door frame between the window opening and the rear edge is able to be increased or decreased.

### SUMMARY

In one embodiment, a door assembly includes a door frame, a frame member, and a garnish. The door frame at least partially defining a window opening. The door frame includes an outer door panel and an inner door panel. The outer door frame includes a window edge adjacent the window opening, a trailing edge, and an exterior surface extending between the window edge and the trailing edge. The inner door panel is coupled to and positioned inboard of the outer door panel in a vehicle lateral direction. The frame member is coupled to and positioned between the outer door panel and the inner door panel. The garnish is coupled to the frame member. The garnish covers a portion of the exterior surface of the outer door panel adjacent the window edge while permitting a vehicle body color of the exterior surface of the door outer panel between the garnish and the trailing edge to be exposed.

In another embodiment, a vehicle includes a door frame, a window, a frame member, and a garnish. The door frame at least partially defining a window opening. The door frame includes an outer door panel and an inner door panel. The outer door frame includes a window edge adjacent the window opening, a trailing edge, and an exterior surface extending between the window edge and the trailing edge. The inner door panel is coupled to and positioned inboard of the outer door panel in a vehicle lateral direction. The window is positioned within the window opening. The frame member is coupled to and positioned between the outer door panel and the inner door panel. The garnish is coupled to the frame member. The garnish covers a portion of the exterior surface of the outer door panel adjacent the window edge while permitting a vehicle body color of the exterior surface of the door outer panel between the garnish and the trailing edge to be exposed.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a side view of a vehicle including a front door assembly and a rear door assembly according to one or more embodiments shown or described herein;

FIG. 2 schematically depicts a partial side view of the rear door assembly of FIG. 1, in which a portion of a garnish and a portion of an outer door panel have been removed, according to one or more embodiments shown or described herein;

FIG. 3 schematically depicts a partial cross-sectional view of the rear door assembly taken along the line 3-3 of FIG. 2, according to one or more embodiments shown or described herein;

FIG. 4 schematically depicts a partial cross-sectional view of the rear door assembly taken along the line 4-4 of FIG. 2, according to one or more embodiments shown or described herein; and

FIG. 5 schematically depicts a partial cross-sectional view of the rear door assembly taken along the line 5-5 of FIG. 2, according to one or more embodiments shown or described herein.

### DETAILED DESCRIPTION

Door assemblies and vehicles including door assemblies are disclosed herein. In one embodiment, a door assembly includes a door frame, a frame member, and a garnish. The door frame at least partially defining a window opening. The door frame includes an outer door panel and an inner door panel. The outer door frame includes a window edge adjacent the window opening, a trailing edge, and an exterior surface extending between the window edge and the trailing edge. The inner door panel is coupled to and positioned inboard of the outer door panel in a vehicle lateral direction. The frame member is coupled to and positioned between the outer door panel and the inner door panel.

The frame member may include an inner wall, an outer wall, and a base wall that extends between the inner wall and the outer wall. The inner wall may be coupled to an inner surface of the inner door panel and the outer wall may be coupled to an interior surface of the outer door panel, the interior surface of the outer door panel being opposite the exterior surface of the outer door panel.

The garnish may include a flange, an inner sidewall, a first curved portion, and an outer sidewall. The flange may be coupled to the base wall of the frame member. The inner sidewall may extend from the flange to the first curved portion in a direction inwardly towards the window opening. The first curved portion may be positioned between the inner sidewall and the outer sidewall such that the outer sidewall extends from first curved portion in a direction outwardly away from the window opening. By coupling the flange of the garnish to the base wall of the frame, a portion of the exterior surface of the outer door panel adjacent the window edge is covered by the outer sidewall of the garnish while permitting a vehicle body color of the exterior surface of the door outer panel between the garnish and the trailing edge to be exposed.

Various embodiments of door assemblies are described in detail below with reference to the appended drawings.

As used herein, the term “vehicle longitudinal direction” refers to the forward-rearward direction of the vehicle (i.e., in the +/− vehicle X-direction as depicted). The term “vehicle lateral direction” refers to the cross-vehicle direction of the vehicle (i.e., in the +/− vehicle Y-direction as depicted), and is transverse to the vehicle longitudinal direction. The term “vehicle vertical direction” refers to the upward-downward direction of the vehicle (i.e., in the +/− vehicle Z-direction as depicted). As used herein, “upper” and “above” are defined as the positive Z direction of the coordinate axis shown in the drawings. “Lower” and “below” are defined as the negative Z direction of the coordinate axis shown in the drawings. Further, the terms “outboard” as used herein refers to the relative location of a component with respect to a vehicle centerline C. The term “inboard” as used herein refers to the relative location of a component with respect to the vehicle centerline C. Because the vehicle structures may be generally symmetrical about the vehicle centerline C, the direction to which use of terms “inboard” or “outboard” and refer may be mirrored about the vehicle centerline C when evaluating components positioned along opposite sides.

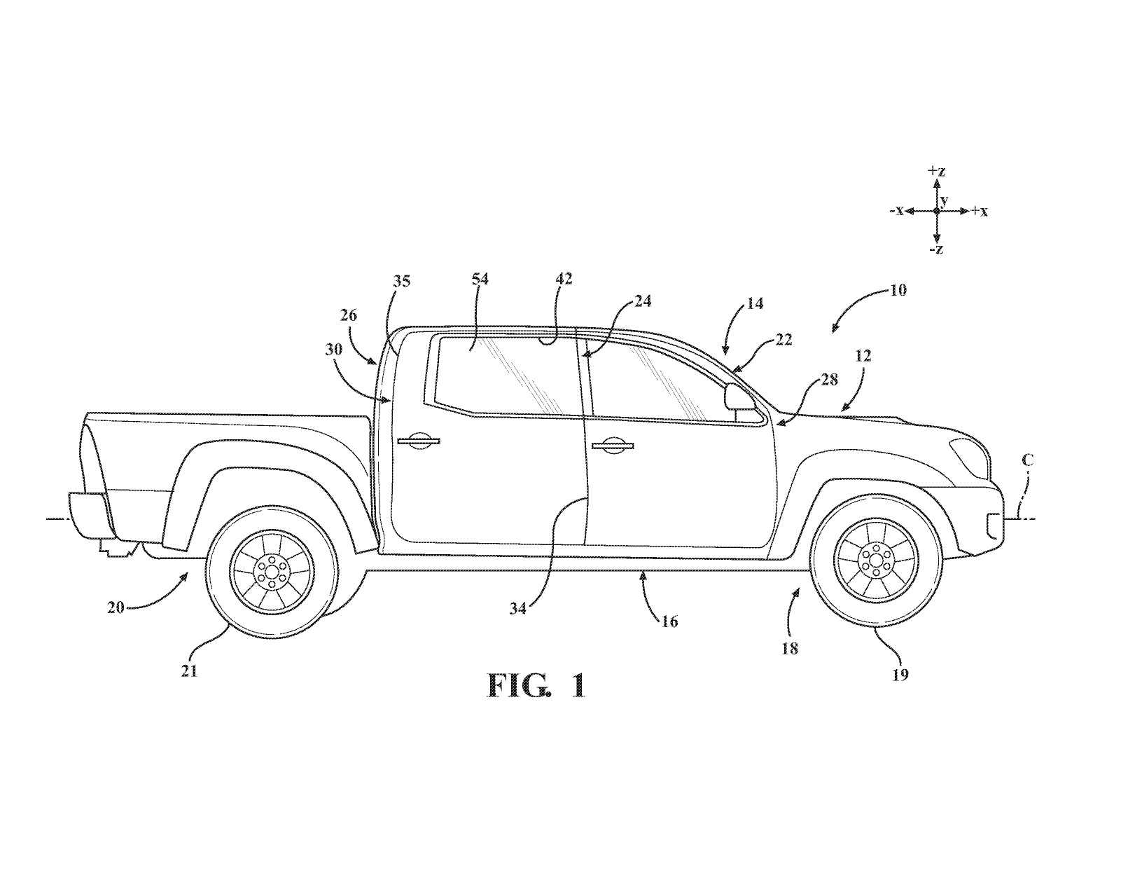

Referring to FIG. 1, a vehicle 10 is depicted. The vehicle 10 includes a body 12. The vehicle 10 also includes a cabin 14 that is integral with the body 12. The cabin 14 generally defines a passenger compartment of the vehicle 10.

The body 12 includes a rocker support 16 that extends in the vehicle longitudinal direction between a front suspension unit 18 and a rear suspension unit 20. The front suspension unit 18 and the rear suspension unit 20 include various components that connect a front tire 19 and a rear tire 21 to the body 12.

The body 12 may include an A-pillar 22, a B-pillar 24, and a C-pillar 26 that extend upward from the rocker support 16 in the vehicle vertical direction. The A-pillar 22 is positioned forward of the B-pillar 24 and the B-pillar 24 is positioned forward of the C-pillar 26. Other bodies may include additional pillars, such as a D-pillar and E-pillar.

The vehicle 10 includes one or more door assemblies coupled to the body 12 of the vehicle 10. A front door assembly 28 is coupled to the A-pillar 22 and a rear door assembly 30 is coupled to the B-pillar 24. In some embodiments, the front door assembly 28 is hingedly coupled to the A-pillar 22 and the rear door assembly 30 is hingedly coupled to the B-pillar 24. In other embodiments, the rear door assembly 30 may be severally coupled to the B-pillar 24, such as when the rear door assembly 30 is sliding door or when the rear door assembly 30 is hingedly coupled to the C-pillar 26 (i.e., a rear-hinged door). The front door assembly 28 and the rear door assembly 30 facilitate ingress and egress to the cabin 14 of the vehicle 10.

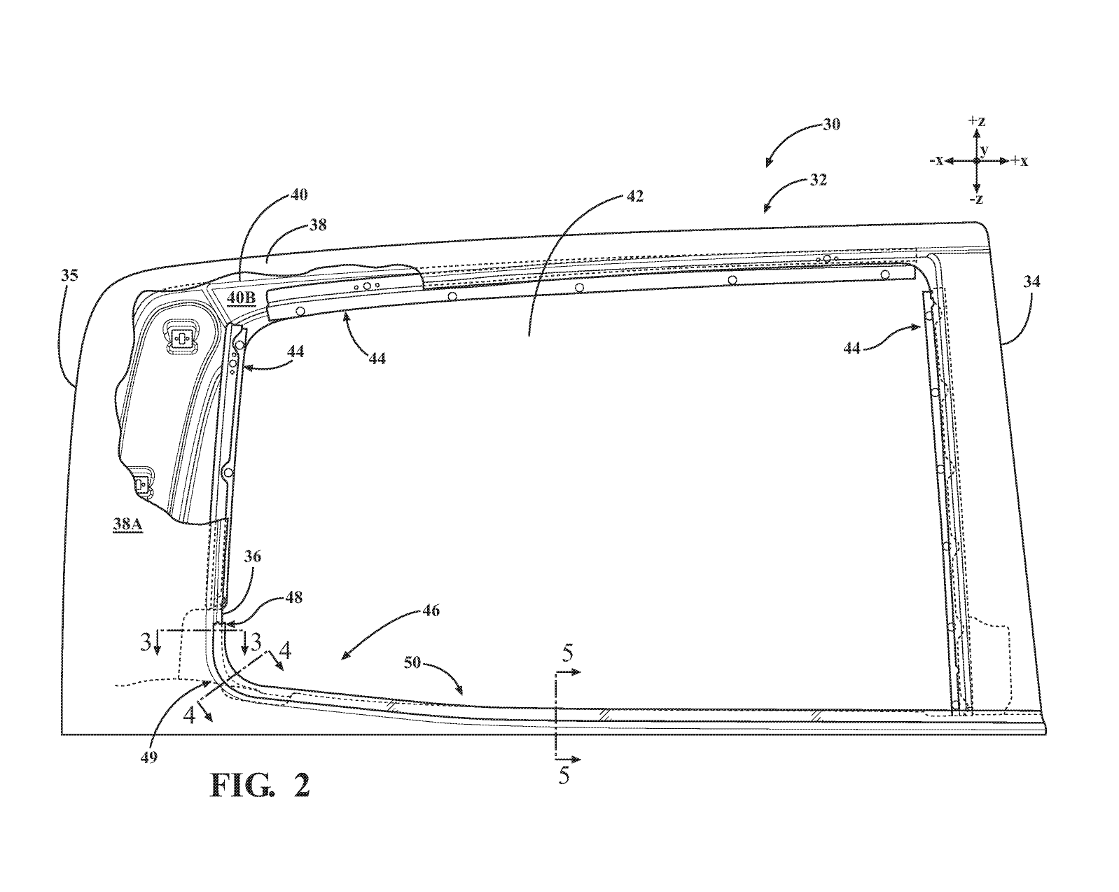

Referring to FIG. 2, the rear door assembly 30 includes a door frame 32 that provides structural support for the rear door assembly 30. The door frame 32 may extend continuously around and at least partially define a window opening 42.

In some embodiments, the rear door assembly 30 may include a window glass 54 that is at least partially received within the window opening 42, as shown in FIG. 1. The window glass 54 may be operable to move between a closed position and an open position. In the closed position, the window glass 54 substantially fills the window opening 42 to prevent access to the cabin 14 through the window opening 42. In the open position, the window glass 54 is displaced in the vehicle vertical direction away from the window opening 42 so as to permit access to the cabin 14 through the window opening 42.

For example, the window glass 54 may be selectively moved in the vehicle vertical direction in the orientation of FIG. 1 between the closed positon and the open position. Specifically, the window glass 54 may be configured to be positioned in various positions between closed positon and open position. In some embodiments, the window glass 54 is operated by mechanical or electrical actuator (not shown). The window glass 54 may be made out of a variety of materials such as glass and plastic.

The door frame 32 includes an outer door panel 38 and an inner door panel 40. In some embodiments, the door frame 32 is a press type door frame in which the outer door panel 38 and the inner door panel 40 extend continuously around the window opening 42.

The outer door panel 38 includes an exterior surface 38A and an opposite interior surface 38B. The exterior surface 38A of the outer door panel 38 may include a vehicle body color, such as a painted surface, that corresponds to a vehicle body color of the body 12. Specifically, the exterior surface 38A of the outer door panel 38 forms a portion of a vehicle exterior such that the vehicle body color of the exterior surface 38A is visible from an exterior of the vehicle 10. The vehicle body color of the exterior surface 38A of the outer door panel 38 is visible from the exterior of the vehicle 10 when the rear door assembly 30 is in a closed position that prevents access into the cabin 14.

The outer door panel 38 may include a leading edge 34, an opposite trailing edge 35, and a window edge 36. The leading edge 34 is positioned adjacent the B-pillar 24. The trailing edge 35 is positioned adjacent the C-pillar 26. The window edge 36 at least partially defines the window opening 42.

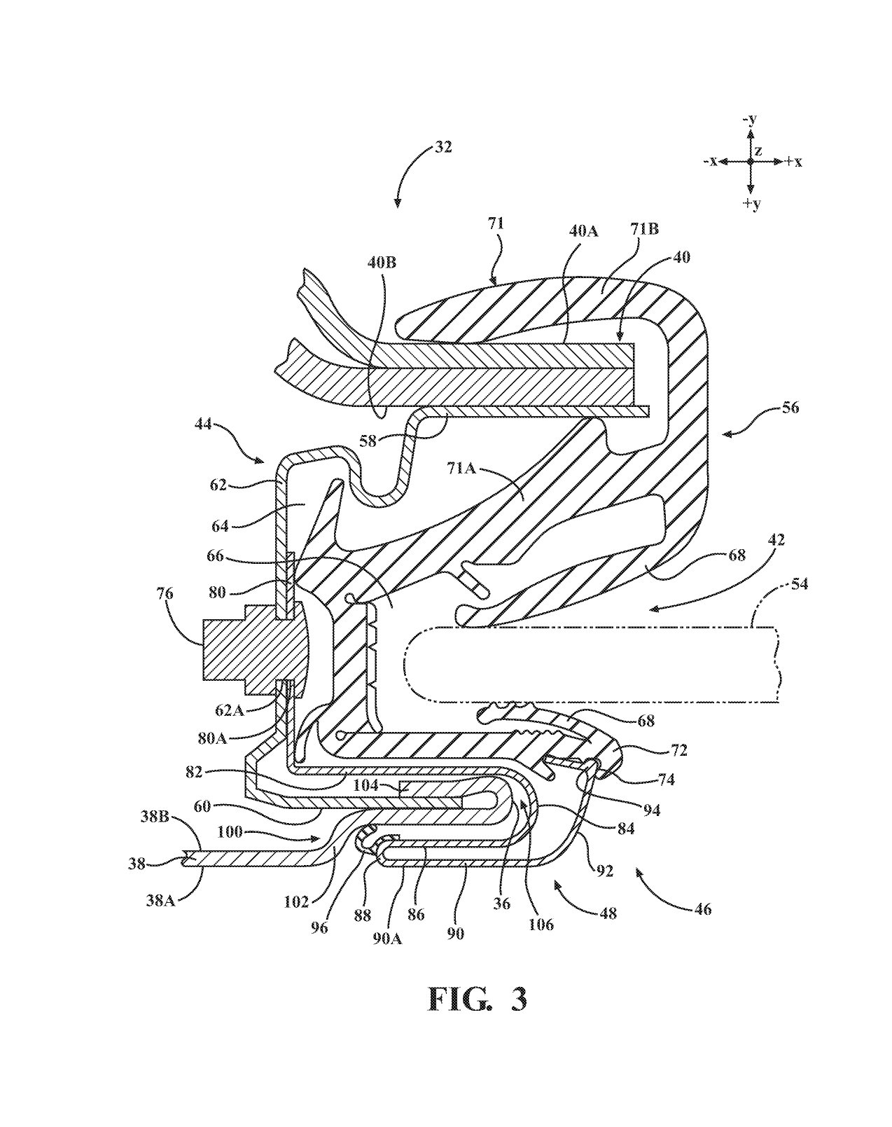

The inner door panel 40 is positioned inboard of the outer door panel 38 in the vehicle lateral direction. The inner door panel 40 includes an inner surface 40A and an opposite outer surface 40B, as shown in FIG. 3. The inner door panel 40 is coupled to the outer door panel 38 to form the door frame 32. Specifically, the inner door panel 40 is coupled to the outer door panel 38 such that the outer surface 40B of the inner door panel 40 faces the interior surface 38B of the outer door panel 38.

The rear door assembly 30 may include a frame member 44 that is coupled to and positioned between the outer door panel 38 and the inner door panel 40. In some embodiments, the rear door assembly 30 includes a single frame member 44 positioned at a rear edge of the window opening 42 in the vehicle longitudinal direction. In other embodiments, the rear door assembly 30 includes a plurality of frame members such as two or three frame members 44. The plurality of frame members 44 may be positioned at the rear edge of the window opening 42 in the vehicle longitudinal direction, and/or a top edge of the window opening 42 in the vehicle vertical direction, and/or a front edge of the window opening 42 in the vehicle longitudinal direction.

The rear door assembly 30 includes a garnish 46 positioned adjacent the window opening 42. The garnish 46 provides an aesthetically pleasing appearance to the rear door assembly 30. The garnish 46 covers a portion of the exterior surface 38A of the outer door panel 38 adjacent the window edge 36 while permitting the vehicle body color of the exterior surface 38A of the outer door panel 38 between the garnish 46 and the trailing edge 35 to be exposed and visible to from the exterior of the vehicle 10 when the rear door assembly 30 is in either a closed position or an open position. Specifically, the garnish 46 covers the portion of the exterior surface 38A of the outer door panel 38 adjacent the window edge 36 such that the portion of the exterior surface 38A of the outer door panel 38 covered by the garnish 46 is neither exposed nor visible from the exterior of the vehicle 10 when the rear door assembly 30 is in either the closed position or the open position. As the garnish 46 is spaced apart from the trailing edge 35 of the door frame 32, the dimensions of the door frame 32 are variable as the portion of the door frame 32 between the window opening 42 and the rear trailing edge 35 is able to be increased or decreased.

The garnish 46 may include a vertical garnish portion 48, a horizontal garnish portion 50, and a corner garnish portion 49. The vertical garnish portion 48 is provided adjacent the rear edge of the window opening 42. The horizontal garnish portion 50 is provided adjacent a bottom edge of the window opening 42 in the vehicle vertical direction. The corner garnish portion 49 is coupled to and positioned between the vertical garnish portion 48 and a horizontal garnish portion 50.

In some embodiments, the garnish 46 is provided as a one piece structure in which the vertical garnish portion 48, the horizontal garnish portion 50, and the corner garnish portion 49 are integrally formed as a one piece monolithic structure. In some embodiments, the garnish 46 is formed of a metallic material illustratively including stainless steel (SUS), chrome, and/or chrome plated steel that is stamped, extruded, and/or shaped to integrally form the vertical garnish portion 48, the horizontal garnish portion 50, and the corner garnish portion 49 as a one piece monolithic structure. In some other embodiments, the garnish 46 is formed of a plastic, resin, and/or polymer material in which the vertical garnish portion 48, the horizontal garnish portion 50, and the corner garnish portion 49 are integrally molded as a one piece monolithic structure

Referring now to FIG. 3, a partial cross sectional view of the vertical garnish portion 48 is schematically depicted. The frame member 44 may include an inner wall 58, an outer wall 60, and a base wall 62. The inner wall 58 is coupled to the inner door panel 40, specifically, the outer surface 40B of the inner door panel 40. The outer wall 60 is coupled to the outer door panel 38, specifically, the interior surface 38B of the outer door panel 38. In some embodiments, the inner wall 58 is welded to the inner door panel 40 and the outer wall 60 is welded to the outer door panel 38. The base wall 62 extends between the inner wall 58 and the outer wall 60 in the vehicle lateral direction. The base wall 62 includes a base wall aperture 62A. In some embodiments, the frame member 44 is formed having a generally U-shaped cross section in which the inner wall 58, the outer wall 60, and the base wall 62 at least partially define a channel 64.

In some embodiments, the rear door assembly 30 may include a weather strip 56 to create at least a partial seal around the window glass 54. The weather strip 56 is at least partially received within the channel 64. The weather strip 56 provides sound and temperature insulation for the window glass 54 and to prevent the ingress of moisture from entering the rear door assembly 30. In some embodiments, the weather strip 56 is provided around the window opening 42.

The weather strip 56 may define a window glass cavity 66 which at least partially receives an edge portion of the window glass 54. The weather strip 56 may also include at least one sealing finger 68 that may extend towards and contact one or more surfaces of window glass 54. In some embodiments, the sealing fingers 68 protrude inwardly towards a center of the window glass cavity 66 and the sealing fingers 68 are biased towards the center position of the window glass cavity 66 such that the sealing fingers 68 contact the window glass 54 to form a seal at least a partial around the window opening 42.

In some embodiments, the weather strip 56 may include a base portion 70, at least one inner retention arm 71, and at least one outer retention arm 73. The inner retention arm 71 and the outer retention arm 73 extend from the base portion 70 inwardly towards the window opening 42. The inner retention arm 71 is positioned inboard of the outer retention arm 73 in the vehicle lateral direction.

The inner retention arm 71 retains the weather strip 56 to the door frame 32, specifically, the inner door panel 40. In some embodiments, the inner retention arm 71 includes a first finger 71A that contacts the inner surface 40A of the inner door panel 40 and a second finger 71B that contacts the outer surface 40B of the inner door panel 40 to retain the weather strip 56 to the inner door panel 40 of the door frame 32.

In some embodiments, the outer retention arm 73 includes a shaped groove 74. As discussed in greater detail below, the shaped groove 74 facilitates the retention of the weather strip 56 to the garnish 46.

Still referring to FIG. 3, the vertical garnish portion 48 may include a flange 80, an inner sidewall 82, a first curved portion 84, and an outer sidewall 86. The flange 80 may extend inwardly in the vehicle lateral direction so as to contact the base wall 62 of the frame member 44. The flange 80 is coupled to the frame member 44. The flange 80 may be coupled to the base wall 62 of the frame member 44.

In some embodiments, the flange 80 may include a flange aperture 80A that corresponds to the base wall aperture 62A, and in which a fastener 76 extends through the flange aperture 80A and the base wall aperture 62A to secure the garnish 46 to the frame member 44. The fastener 76 may be a rivet, an adhesive, a weld, such as a spot weld, a bolt, or a screw.

The inner sidewall 82 extends from the flange 80 in a direction inwardly towards the window opening 42. The first curved portion 84 is positioned between the inner sidewall 82 and the outer sidewall 86 such that the outer sidewall 86 extends from the first curved portion 84 outwardly away from the window opening 42. In some embodiments, the first curved portion 84 is formed having a generally U-shape and in which a portion of the outer door panel 38 adjacent the window edge 36 is received within the first curved portion 84. In some embodiments, the inner sidewall 82 and the outer sidewall 86 extend substantially parallel to each other and substantially parallel to the vehicle longitudinal.

In some embodiments, the outer door panel 38 is formed having a hooked portion 106 that secures an edge of the outer wall 60 of the frame member 44 such that an overlap portion 104 extends into the channel 64. The hooked portion 106 forms at least a portion of the window edge 36 of the outer door panel 38. As shown in FIG. 3, a portion of the window edge 36, including the hooked portion 106, is positioned between the inner sidewall 82 and the outer sidewall 86. As such, a portion of the exterior surface 38A of the outer door panel 38 adjacent the window edge 36 is covered by the outer sidewall 86 of the garnish 46 while permitting the vehicle body color of the exterior surface 38A of the outer door panel 38 between the garnish 46 and the trailing edge 35 to be exposed.

In some embodiments, the outer door panel 38 includes an offset portion 100 that is offset inwardly in the vehicle lateral direction with respect to a remaining portion of the outer door panel 38 such that at least a portion of the outer surface 90A of the exposed wall 90 is substantially coplanar with at least a portion of the exterior surface 38A of the outer door panel 38 in which the vehicle body color is exposed. For example, the outer surface 90A of the exposed wall 90 is substantially coplanar (i.e. substantially aligned on a single plane) with the portion of the exterior surface 38A of the outer door panel 38 that is positioned between the offset portion 100 and the trailing edge 35. Specifically, the outer door panel 38 includes a bent portion 102 that bends inwardly in the vehicle lateral direction such that the hooked portion 106 is positioned inwardly in the vehicle lateral direction with respect to the outer sidewall 86.

The vertical garnish portion 48 may also include a second curved portion 88 and an exposed wall 90. The second curved portion 88 is positioned between the outer sidewall 86 and the exposed wall 90 such that the exposed wall 90 extends from the second curved portion 88 inwardly towards the window opening 42. In some embodiments, the second curved portion 88 is formed having a generally U-shape such that the exposed wall 90 is positioned outboard, in the vehicle lateral direction, of the outer sidewall 86 which is positioned outboard, in the vehicle lateral direction, of the exterior surface 38A of the outer door panel 38 adjacent the window edge 36. As such, a portion of the exterior surface 38A of the outer door panel 38 adjacent the window edge 36 is covered by the outer sidewall 86 and the exposed wall 90 of the garnish 46 while permitting the vehicle body color of the exterior surface 38A of the outer door panel 38 between the garnish 46 and the trailing edge 35 to be exposed. In some embodiments, the inner sidewall 82, the outer sidewall 86, and the exposed wall 90 extend substantially parallel to each other and substantially parallel to the vehicle longitudinal.

The vertical garnish portion 48 may also include an edge wall 92 that extends inwardly in the vehicle lateral direction towards the window opening 42. The edge wall 92 includes an edge portion 94 having a shape that corresponds to the shaped groove 74 of the outer retention arm 73. The edge portion 94 is at least partially received within the shaped groove 74 such that the shape of the edge portion 94 engages within the shaped groove 74 to retain a position of the the outer retention arm 73 of the weather strip 56 with respect to the garnish 46.

In some embodiments, a garnish seal 96 is provided between the garnish 46 and the exterior surface 38A of the outer door panel 38. The garnish seal 96 prevents the ingress of moisture from entering between the garnish 46 and the outer door panel 38. Specifically, the garnish seal 96 prevents the ingress of moisture from entering between the outer sidewall 86 and the exterior surface 38A of the outer door panel 38.

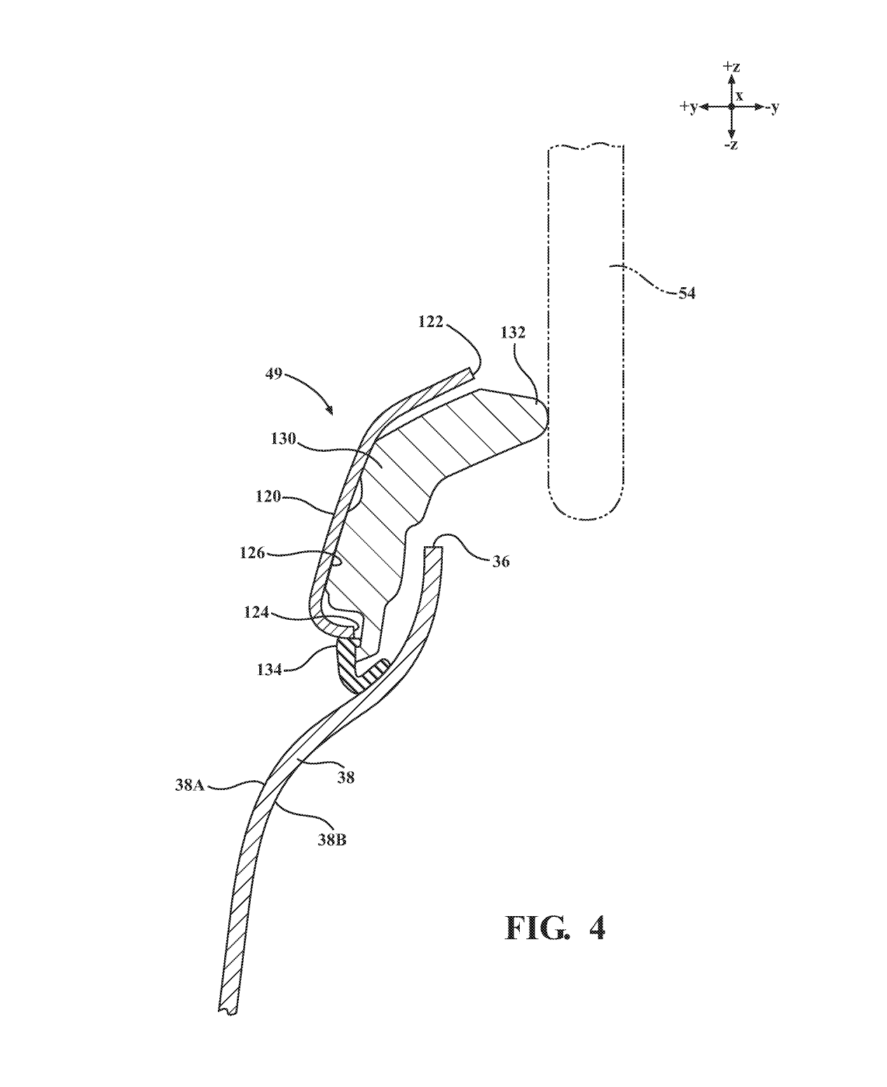

Referring to FIG. 4, a cross sectional view of the corner garnish portion 49 is depicted. The corner garnish portion 49 covers a portion of the outer door panel 38 adjacent the bottom edge of the window opening 42. The corner garnish portion 49 may include a corner wall 120 a having an upper edge 122 and a lower edge 124. The upper edge 122 is positioned above, in the vehicle vertical direction, the window edge 36, and the lower edge 124 is positioned below, in the vehicle vertical direction, the window edge 36. The corner wall 120 covers a junction between the window edge 36 and a lower end 54A of the window glass 54.

The corner garnish portion 49 may also include a reinforcement strip 130 The reinforcement strip 130 includes a seal finger 132 that engages the window glass 54 to form a seal with the window glass 54 to prevent the ingress of moisture. In some embodiments, the reinforcement strip 130 is formed as a reinforcement between the vertical garnish portion 48 and the horizontal garnish portion 50. The reinforcement strip 130 contacts an interior surface 126 of the corner wall 120. In some embodiments, the reinforcement strip 130 is formed integrally with the corner wall 120 as a one piece monolithic structure.

The corner garnish portion 49 may also include a garnish seal 134 provided between the corner garnish portion 49 and the exterior surface 38A of the outer door panel 38. The garnish seal 134 prevents the ingress of moisture from entering between the corner garnish portion 49 and the outer door panel 38. Specifically, the garnish seal 134 prevents the ingress of moisture from entering between the corner wall 120 and the exterior surface 38A of the outer door panel 38.

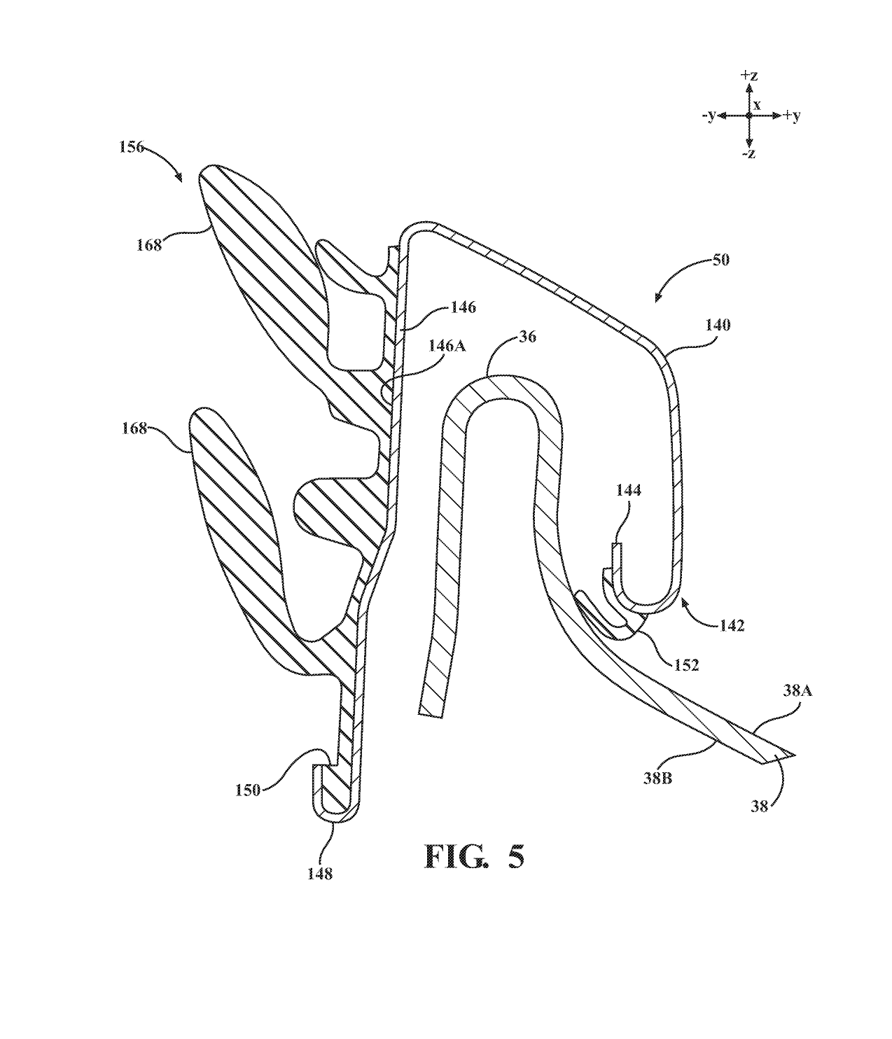

Referring to FIG. 5, a cross sectional view of the horizontal garnish portion 50 is depicted. The horizontal garnish portion 50 extends along a belt line of the rear door assembly 30. The horizontal garnish portion 50 includes a belt wall 140 and a contact wall 146. The belt wall 140 includes a retainer portion 142 having a generally U-shape and a distal end 144. The distal end 144 is positioned above the retainer portion 142 in the vehicle vertical direction. The retainer portion 142 and the distal end 144 are positioned below the window edge 36 of the outer door panel 38 in the vehicle vertical direction.

In some embodiments, the horizontal garnish portion 50 includes a garnish seal 152 that extends between the retainer portion 142 and the outer door panel 38. The garnish seal 152 prevents the ingress of moisture from entering between the horizontal garnish portion 50 and the outer door panel 38. Specifically, the garnish seal 152 prevents the ingress of moisture from entering between the belt wall 140 and the exterior surface 38A of the outer door panel 38.

The horizontal garnish portion 50 may also include a contact wall 146 that extend downwardly in the vehicle vertical direction from the belt wall 140. An inner surface 146A of the contact wall 146 contacts a weather strip 156. The contact wall 146 may include a hook 148 that retains a lower edge 150 of the weather strip 156. The hook 148 facilitates the retention of the weather strip 156 to the horizontal garnish portion 50.

The weather strip 156 includes sealing fingers 168 that contact a portion of the window glass 54. In some embodiments, the weather strip 156 is integrally molded as a one piece monolithic structure with the weather strip 56. In some other embodiments, the weather strip 156 is a separate structure from the weather strip 56.

In some embodiments, the weather strip 56, the weather strip 156, the garnish seal 96, the garnish seal 134, and the garnish seal 152 may be formed from a variety of natural or synthetic materials, illustratively including a thermoplastic elastomer (TPE) such as thermoplastic vulcanisate (TPV). TPV materials may give consistent and predictable performance, extended durability, and light and moisture resistance.

In the illustrated embodiments, the garnish 46 is provided on the rear door assembly 30. However, the garnish 46 is not limited to use with the rear door assembly 30 and can be utilized in the front door assembly 28.

In some embodiments, the vehicle 10 is a truck. In some other embodiments, the vehicle 10 may be a car, a sport utility vehicle, a van, a boat, a plane, or other vehicle types.

It should now be understood that the present disclosure includes door assemblies and vehicles including door assemblies. In embodiments, the door assembly includes a door frame, a frame member, and a garnish. The door frame at least partially defining a window opening. The door frame includes an outer door panel and an inner door panel. The outer door frame includes a window edge adjacent the window opening, a trailing edge, and an exterior surface extending between the window edge and the trailing edge. The inner door panel is coupled to and positioned inboard of the outer door panel in a vehicle lateral direction. The frame member is coupled to and positioned between the outer door panel and the inner door panel. The frame member may include an inner wall, an outer wall, and a base wall that extends between the inner wall and the outer wall. The inner wall may be coupled to an inner surface of the inner door panel and the outer wall may be coupled to an interior surface of the outer door panel, the interior surface of the outer door panel being opposite the exterior surface of the outer door panel. The garnish may include a flange, an inner sidewall, a first curved portion, and an outer sidewall. The flange may be coupled to the base wall of the frame member. The inner sidewall may extend from the flange to the first curved portion in a direction inwardly towards the window opening. The first curved portion may be positioned between the inner sidewall and the outer sidewall such that the outer sidewall extends from first curved portion in a direction outwardly away from the window opening. By coupling the flange of the garnish to the base wall of the frame, a portion of the exterior surface of the outer door panel adjacent the window edge is covered by the outer sidewall of the garnish while permitting a vehicle body color of the exterior surface of the door outer panel between the garnish and the trailing edge to be exposed.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A door assembly comprising:
a door frame at least partially defining a window opening, the door frame includes an outer door panel and an inner door panel, the outer door frame includes a window edge adjacent the window opening, a trailing edge, and an exterior surface extending between the window edge and the trailing edge, the inner door panel is coupled to and positioned inboard of the outer door panel in a vehicle lateral direction;
a frame member coupled to and positioned between the outer door panel and the inner door panel; and
a garnish coupled to the frame member, the garnish covers a portion of the exterior surface of the outer door panel adjacent the window edge while permitting a vehicle body color of the exterior surface of the door outer panel between the garnish and the trailing edge to be exposed.

2. The door assembly of claim 1, wherein the frame member includes an inner wall, an outer wall, and a base wall that extends between the inner wall and the outer wall, the inner wall coupled to an inner surface of the inner door panel and the outer wall coupled to an interior surface of the outer door panel, the interior surface of the outer door panel being opposite the exterior surface of the outer door panel.

3. The door assembly of claim 2, wherein the garnish is coupled to the base wall of the frame member.

4. The door assembly of claim 3, wherein the garnish includes a flange, an inner sidewall, a first curved portion, and an outer sidewall, the flange is coupled to the base wall of the frame member, the inner sidewall extends from the flange to the first curved portion in a direction inwardly towards the window opening, the first curved portion is positioned between the inner sidewall and the outer sidewall such that the outer sidewall extends from first curved portion in a direction outwardly away from the window opening.

5. The door assembly of claim 4, wherein the outer sidewall covers the portion of the exterior surface of the outer door panel adjacent the window edge.

6. The door assembly of claim 5, wherein the garnish includes a second curved portion and an exposed sidewall, the second curved portion is positioned between the outer sidewall and the exposed sidewall such that the exposed sidewall extends from the second curved portion in the direction inwardly towards the window opening.

7. The door assembly of claim 6 further comprising a weather strip that includes a window glass cavity configured to receive a window,
wherein the inner sidewall, the outer sidewall, and the base wall of the frame member at least partially define a channel, the weather strip at least partially received within the channel.

8. The door assembly of claim 7, wherein the garnish includes an edge wall that includes an edge portion, and
wherein the weather strip includes a shaped groove that includes a shape that corresponds to a shape of the edge portion, the edge portion is received within the shaped groove to retain a position of the weather strip.

9. The door assembly of claim 8, wherein a portion of the outer door panel adjacent the window edge is offset inwardly in the vehicle lateral direction such that at least a portion of an outer surface of the exposed sidewall is substantially coplanar with at least a portion of the exterior surface of the door outer panel in which the vehicle body color is exposed.

10. The door assembly of claim 9, wherein the garnish includes a seal positioned between the second curved portion and the exterior surface of the door outer panel.

11. A vehicle comprising:
a door frame at least partially defining a window opening, the door frame includes an outer door panel and an inner door panel, the outer door frame includes a window edge adjacent the window opening, a trailing edge, and an exterior surface extending between the window edge and the trailing edge, the inner door panel is coupled to and positioned inboard of the outer door panel in a vehicle lateral direction;
a window positioned within the window opening;
a frame member that is coupled to and positioned between the outer door panel and the inner door panel; and
a garnish coupled to the frame member, the garnish covers a portion of the exterior surface of the outer door panel adjacent the window edge while permitting a vehicle body color of the exterior surface of the door outer panel between the garnish and the trailing edge to be exposed.

12. The vehicle of claim 11, wherein the frame member includes an inner wall, an outer wall, and a base wall that extends between the inner wall and the outer wall, the inner wall coupled to an inner surface of the inner door panel and the outer wall coupled to an interior surface of the outer door panel, the interior surface of the outer door panel being opposite the exterior surface of the outer door panel.

13. The vehicle of claim 12, wherein the garnish is coupled to the base wall of the frame member.

14. The vehicle of claim 13, wherein the garnish includes a flange, an inner sidewall, a first curved portion, and an outer sidewall, the flange is coupled to the base wall of the frame member, the inner sidewall extends from the flange to the first curved portion in a direction inwardly towards the window opening, the first curved portion is positioned between the inner sidewall and the outer sidewall such that the outer sidewall extends from first curved portion in a direction outwardly away from the window opening.

15. The vehicle of claim 14, wherein the outer sidewall covers the portion of the exterior surface of the outer door panel adjacent the window edge.

16. The vehicle of claim 15, wherein the garnish includes a second curved portion and an exposed sidewall, the second curved portion is positioned between the outer sidewall and the exposed sidewall such that the exposed sidewall extends from the second curved portion in the direction inwardly towards the window opening.

17. The vehicle of claim 16 further comprising a weather strip that includes a window glass cavity configured to receive the window,
wherein the inner sidewall, the outer sidewall, and the base wall of the frame member at least partially define a channel, the weather strip at least partially received within the channel.

18. The vehicle of claim 17, wherein the garnish includes an edge wall that includes an edge portion, and
wherein the weather strip includes a shaped groove that includes a shape that correspond to a shape of the edge portion, the edge portion is received within the shaped groove to retain a position of the weather strip.

19. The vehicle of claim 18, wherein a portion of the outer door panel adjacent the window edge is offset inwardly in the vehicle lateral direction such that at least a portion of an outer surface of the exposed sidewall is substantially coplanar with at least a portion of the exterior surface of the door outer panel in which the vehicle body color is exposed.

20. The vehicle of claim 19, wherein the garnish includes a seal positioned between the second curved portion and the exterior surface of the door outer panel.
